(19) United States
(12) Patent Application Publication
(10) Pub. No.: US 2026/0017427 A1
(43) Pub. Date: Jan. 15, 2026

(54) Three-Dimensional Truss Optimal Designing and Manufacturing Method Based on Relaxed Modular Constraint

(71) Applicants: Hangzhou City University, Hangzhou City (CN); Zhejiang Inst. of Architectural Design & Research, Hangzhou City (CN)

(72) Inventors: Zhen Wang, Hangzhou City (CN); Jun Ye, Hangzhou City (CN); Yang Zhao, Hangzhou City (CN); Xuelin Yang, Hangzhou City (CN); Yufeng Liu, Hangzhou City (CN); Huizhen Huang, Hangzhou City (CN); Hongjia Lu, Hangzhou City (CN); Huiping Tang, Hangzhou City (CN)

(21) Appl. No.: 19/174,291

(22) Filed: Apr. 9, 2025

(30) Foreign Application Priority Data
Jul. 15, 2024 (CN) 202410939375.8

(51) Int. Cl. G06F 30/20; G06F 17/11; G06F 111/04; G06F 111/10

(52) U.S. Cl. CPC G06F 30/20; G06F 17/11; G06F 2111/04; G06F 2111/10

(57) ABSTRACT

Provided is a three-dimensional truss optimal designing and manufacturing method based on relaxed modular constraint. The method includes the following steps: initial design layout optimization, cluster analysis identification module arrangement, relaxed modular constraint design, geometric optimization, and 3D printing manufacturing and integrated assembly. The method has the following beneficial effect. A three-dimensional truss structure containing various module types is automatically designed by an iterative method. In the iterative process, a cluster analysis method is introduced to identify the module arrangement. By applying relaxed modular constraints, an optimized solution is gradually pushed to the modular structure. The optimization results of the three-dimensional truss have the characteristics of various types of modular structures, which is relatively easy to manufacture. An iterative solution method of cluster analysis identification module arrangement and relaxed modular constraint design is proposed.

### CROSS-REFERENCE TO RELATED PRESENT DISCLOSURE

This patent application claims the benefit and priority of Chinese Patent Application No. 202410939375.8 filed with the China National Intellectual Property Administration on Jul. 15, 2024, the disclosure of which is incorporated by reference herein in its entirety as part of the application.

### TECHNICAL FIELD

The present disclosure belongs to the technical fields of structural engineering and additive manufacturing, and in particular, relates to a three-dimensional truss optimal designing and manufacturing method based on relaxed modular constraint.

### BACKGROUND

A modular structure is widely used in the field of civil engineering because of its advantages of low cost, high quality and fast construction, and is used in the design and construction of structures such as prefabricated buildings and deployable bridges. However, the design of the modular structure involves not only a local modular structure, but also the overall modular arrangement. In order to fully release the potential of the modular structure, relevant digital design methods are urgently needed.

The continuum topology optimization represents a main trend of the structural design, which is based on the elastic design theory and the finite element discretization. The continuum topology optimization methods include a solid isotropic material method with penalty, a Bi-directional Evolutionary Structural Optimization (BESO), a level set method, a moving morphable component method and a moving morphable void method.

The concept of the modular structures has been widely used in structural optimization, most of which are based on the continuum topology optimization method. The method mainly includes two branches. One branch focuses on the topology design of a micro-structure, regards modular cells as infinitesimal with respect to the design field, and uses a homogenization method. The other branch focuses on the topology design of a macro-structure, and designs the optimized structure formed by a small number of specified building modules through the pioneering technology.

However, the research on continuum topology optimization of a truss often relies on a predefined module or only uses one module type. The structure and arrangement of the module at the same time are optimized, so that in combination with various module types, the increase of the structural volume resulted from modular constraints can be effectively reduced. However, taking into account the complexity of design problems, this method will also result in high calculation cost, which limits its application in large-scale three-dimensional truss optimization problems. In the field of the structural design, a meta-heuristic algorithm can be used to solve complex optimization problems, including a genetic algorithm, a heuristic particle swarm optimization and an ant colony optimization algorithm. Combining different evolutionary strategies can make full use of their respective advantages and embed the initial feasible solution into a specific algorithm to improve the calculation efficiency. Therefore, the current research difficulty is how to use the truss layout optimization method to design various types of modular structures.

To sum up, it is very necessary to research a new three-dimensional truss optimal designing and manufacturing method, which can significantly reduce the cost while the structural volume changes little, and realize the modular cell layout optimization and the three-dimension (3D) printing manufacturing and integrated assembly of large-scale complex three-dimensional truss structures.

### SUMMARY

The purpose of the present disclosure is to overcome the shortcomings in the prior art and provide a three-dimensional truss optimal designing and manufacturing method based on relaxed modular constraint.

The three-dimensional truss optimal designing and manufacturing method based on relaxed modular constraint includes following steps:
step S1, performing initial design layout optimization, including carrying out initial design layout optimization with a minimum total volume of members as a design objective to obtain an initial solution of layout optimization, and setting the initial solution as a strict lower bound;
step S2, performing modular design layout optimization, including repeating step S2.1 and step S2.2 to refine the initial solution of layout optimization into a modular design optimized solution of layout optimization;
step S2.1, performing cluster analysis identification module arrangement, including checking structural layout by cluster analysis, identifying module arrangement, and solving a strict modular constraint optimization problem;
step S2.2, performing relaxed modular constraint design, including re-optimizing a structure through the relaxed modular constraint by using module arrangement;
step S3, performing geometric optimization, including performing geometric optimization processing on a layout optimization result to obtain a reasonable and effective optimization structure;
step S4, performing 3D printing manufacturing and integrated assembly, including: performing 3D printing manufacturing on a plurality of optimized modular cells, and performing integrated assembly among the modular cells to manufacture an optimized structure.

In an embodiment, in step S1, a corresponding objective function with the minimum total volume of the members as the design objective is:

$${min V}_{a , q , x , y} = {l ( x , y )}^{T} a \qquad ( 1 )$$

an equilibrium equation of a force, a stress constraint of the members and a non-negative constraint of a member cross-sectional area are introduced as constraint conditions of Formula (1), and an expression of the constraint conditions is:

$$\{ \begin{matrix}B ( x , y ) q = f \\ - {σ}_{c} a \leq q \leq {σ}_{t} a \\ a \geq 0\end{matrix} \qquad ( 2 )$$

where V is a total volume of the members, l(x, y) is a vector of a member length, a is a vector of the member area, B(x, y) is an equilibrium matrix, q is a vector of a member internal force, f is a vector of a node load, and σ_{c} and σₜ are allowable compression strength and allowable tensile strength of the members, respectively; x=[x₁, x₂, . . . , xₗ]^{T} and y=[y₁, y₂, . . . , yₗ]^{T} are an x coordinate vector and y coordinate vector of the nodes, respectively, and l is the number of the nodes.

In an embodiment, in step S1, a design domain and a boundary condition are defined first, the design domain is then discretized into a node grid, and a base structure including all possible connections between nodes is constructed; a subset structure is identified and optimized from the base structure; and geometric optimization is performed based on design variables of node coordinates.

In an embodiment, in step S2.1, objects in a data set are divided into different groups by cluster analysis according to similarity, the similarity is quantified by an Euclidean distance to obtain a cluster index c as follows:

$$c = arg {min}_{S} {\sum }_{ϕ = 1}^{p} {\sum }_{ζ ∈ {S}_{ϕ}} {‖ ζ - {μ}_{ϕ} ‖}^{2} \qquad ( 3 )$$

where S={S₁, S₂, . . . , S_{ϕ}, . . . , Sₚ} is a data cluster set, where S_{ϕ} denotes a ϕ-th data cluster, and p is a total number of data clusters, which is equal to the number of module types in is a centroid of the optimization problem; ζ is a data point belonging to S_{ϕ};

$${μ}_{ϕ} = \frac{1}{\vert {S}_{ϕ} \vert} {\sum }_{ζ ∈ {S}_{ϕ}} ζ$$

is a centroid pf S_{ϕ}, where |S_{ϕ}| is a corresponding number of data points;

using a cluster analysis algorithm to extract a modular arrangement from existing structure according to divided groups, includes: first, giving the design domain and the boundary condition, obtaining an optimal modular arrangement by using a regional volume as data for clustering, that is, setting ζ=νₛ in Formula (3), where νₛ is the regional volume; finally, solving a linear programming problem to obtain corresponding modular optimization structure after re-optimization, and solving a strict modular optimization problem, that is, a nominal lower bound solution.

In an embodiment, in step S2.1, for an expression of solving the strict modular constraint optimization problem, an objective function is:

$${min V}_{a , q , {A}_{m} , x , y} = {l ( x , y )}^{T} a \qquad ( 4 )$$

an expression of the constraint conditions is:

$$\{ \begin{matrix}B ( x , y ) q = f \\ - {σ}_{c} a \leq q \leq {σ}_{t} a \\ a \geq 0 \\ {a}_{i} = {\sum }_{j = 1}^{p} {A}_{m , j} {t}_{j} , ∀ i ∈ \{ 1 , 2 , … , n \}\end{matrix} \qquad ( 5 )$$

where tⱼ is a binary constant representing a j-th module type number in each module space, which reflects whether a corresponding module type is activated; p is the number of module types, and n is the number of members; A_{m,j} is an optional area of a member in a j-th module.

In an embodiment, in step S2.2, given structures of different module types are set; an element-based modular constraint is set to ensure that internal structures of the module spaces of a same module type are all same; each module space is divided into d×d sub-regions, where each sub-region has its corresponding structure, volume of the sub-regions is constrained by following expression:

$${v}_{s , ( k , b )} = {v}_{t , ( j , b )} , ∀ k ∈ {H}_{j} , b = 1 , 2 , … , {d}^{2} \qquad ( 6 )$$

$${v}_{s , ( k , b )} = {\sum }_{m ∈ {Ω}_{k , b}} {a}_{k , m} {l}_{k . m} \qquad ( 7 )$$

where ν_{s,(k,b)} denotes a structural volume of a b-th sub-region in a k-th module space, ν_{t,(j,b)} denotes a total volume of a b-th module region in a j-th module type; Hⱼ denotes an index set of module spaces when the j-th module type is used; Ω_{k,b} is the b-th sub-region in the k-th module space; a_{k,m} and l_{k,m} are a cross-sectional area and length of a member in the b-th sub-region, respectively, and m is a member number.

A fourth expression in Formula (5) is replaced by Formula (6) and Formula (7), and an expression of the relaxed modular constraint design is obtained.

In an embodiment, in step S2.2, the modular constraint is capable of being strengthened by systematically increasing a value of d; in order to solve a convergence problem resulted from a discrete jump of sub-regions due to the increase of the value of d, Formula (6) is modified to Formula (8), which is expressed as follow:

$$( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \qquad ( 8 )$$

where r is an influencing factor, 0≤r≤1, when r=1, the constraint Formula (6) is completely eliminated, and when r=0, the constraint Formula (6) is fully applied, that is, a stricter modular constraint; in the whole iterative process, a value of r starts from being close to 1 and gradually decreases to 0.

In an embodiment, in step S2.2, for an expression of solving a relaxed modular constraint optimization problem, an objective function is:

$${min V}_{a , q , {v}_{t} , {v}_{s} , x , y} = {l ( x , y )}^{T} a \qquad ( 9 )$$

the expression of constraint conditions is:

$$\{ \begin{matrix}B ( x , y ) q = f \\ - {σ}_{c} a \leq q \leq {σ}_{t} a \\ a \geq 0 \\ ( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \\ {v}_{s , ( k , b )} = {\sum }_{m ∈ {Ω}_{k , b}} {a}_{k , m} {l}_{k . m}\end{matrix} \qquad ( 10 )$$

where the constraint condition Formula (10) consists of first three expressions of Formula (5), Formula (7) and Formula (8).

In an embodiment, in step S2, an improved iterative implementation strategy is used from step S2.1 to step S2.2 to improve a final optimization result, which includes: after step S2.1, when ν_{ξ}≤ν_{ξ-1}, updating the module arrangement, and then implementing step S2.2 to solve the relaxed modular constraint optimization problem; when ν_{ξ}≤ν_{ξ-1}, implementing step S2.2 directly to solve the relaxed modular constraint optimization problem; where ν_{ξ} is a volume of a modular optimization structure, which is solved by Formula (5); ξ is the number of iterations, and ξₘₐₓ is a predetermined maximum number of iterations.

The present disclosure has the following beneficial effect.

1) According to the three-dimensional truss optimal designing and manufacturing method based on relaxed modular constraint provided by the present disclosure, a three-dimensional truss structure containing various module types is automatically designed by an iterative method. In the iterative process, a cluster analysis method is introduced to identify the module arrangement. By applying relaxed modular constraints, an optimized solution is gradually pushed to the modular structure. The optimization results of the three-dimensional truss have the characteristics of various types of modular structures, which is relatively easy to manufacture.

2) According to the three-dimensional truss optimal designing and manufacturing method based on relaxed modular constraint provided by the present disclosure, based on the initial truss layout optimization, aiming at the problem of excessive calculation when solving large-scale three-dimensional truss optimization problems, an iterative solution method of cluster analysis identification module arrangement and relaxed modular constraint design is proposed, so that a stress path of the structure is clearer, and the calculation efficiency is significantly improved with little influence on a final optimized structural volume.

3) According to the three-dimensional truss optimal designing and manufacturing method based on relaxed modular constraint provided by the present disclosure, based on the mathematical model of truss layout optimization, fast and efficient solution based on relaxed modular constraints is realized through the iterative solution mode of cluster analysis identification module arrangement. The relaxed modular constraints of various types of modules are set, so that the module repeatability and the structural regularity of the optimization results are realized. Through 3D modeling, modular structure model slicing, printing path generation and integrated assembly production, 3D printing optimization design and integrated assembly manufacturing of a complex three-dimensional truss optimization structure are realized.

### BRIEF DESCRIPTION OF THE DRAWINGS

FIG. 1 is a schematic diagram of an overall optimization flow of step S2 and step S3 according to the present disclosure.

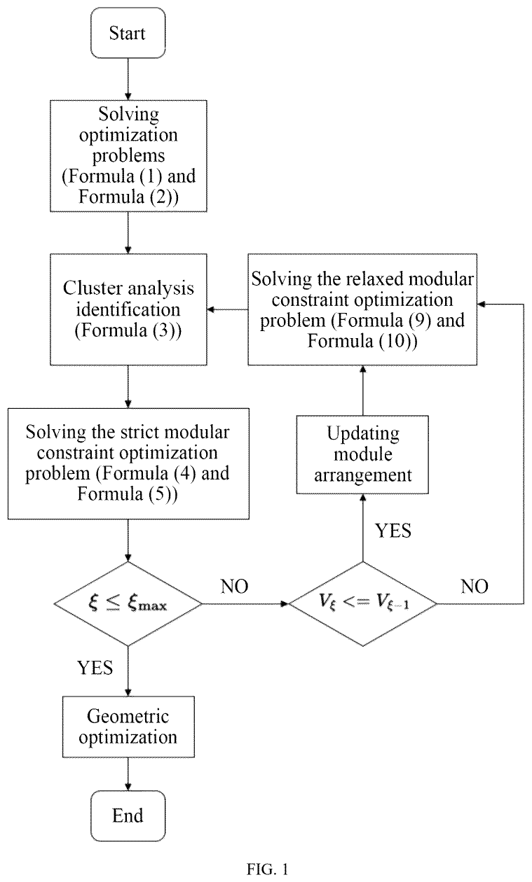

FIGS. 2A-2D are schematic diagrams of a process of initial design layout optimization in step S1 (FIG. 2A is a schematic diagram of defining a design domain and a boundary condition, FIG. 2B is a schematic diagram of generating a base structure, FIG. 2C is a schematic diagram of identifying and optimizing a subset structure, and FIG. 2D is a schematic diagram of geometric optimization).

FIGS. 3A-3C are schematic diagrams of a process of cluster analysis identification module arrangement in step S2.1 (FIG. 3A is a schematic diagram of a given design domain and a given boundary condition, FIG. 3B is a schematic diagram of cluster analysis identification module arrangement, and FIG. 3C is a schematic diagram of a strict modular constraint re-optimization structure).

FIGS. 4A-4D are schematic diagrams of a process of a relaxed modular constraint design in step S2.2 (FIG. 4A is a schematic structural diagram of setting different module types, FIG. 4B is a schematic diagram of setting element-based modular constraints, FIG. 4C is a schematic diagram of relaxed modular constraints, and FIG. 4D is a schematic diagram of region-based relaxed modular constraints).

FIG. 5 is a schematic diagram of a semi-structural model of a simple bridge embodiment.

FIG. 6 is a schematic diagram of an iterative process of a simple bridge embodiment.

FIG. 7 shows the changes of a structural volume, a variable d and a variable r in an iterative process.

FIGS. 8A-8B are schematic diagrams of module arrangement of a square roof structure (FIG. 8A is a top view of a square roof structure, and FIG. 8B is a front view of a square roof structure).

FIG. 9 is a three-dimensional schematic diagram of a full-span vertical load of a square roof structure.

FIGS. 10A-10C shows optimization results of a square roof structure in the case of six different module types (FIG. 10A is a top view of optimization results, FIG. 10B is a axonometric drawing of optimization results, and FIG. 10C is a schematic diagram of six different module types).

### DETAILED DESCRIPTION OF THE EMBODIMENTS

The present disclosure will be further described with reference to embodiments hereinafter. The description of the following embodiments is only for the purpose of helping to understand the present disclosure. It should be pointed out that for those skilled in the art, several modifications can be made to the present disclosure without departing from the principle of the present disclosure. These improvements and modifications also fall within the scope of protection of the claims of the present disclosure.

### Embodiment 1

As an embodiment, the three-dimensional truss optimal designing and manufacturing method based on relaxed modular constraint includes the following steps S1 to S4.

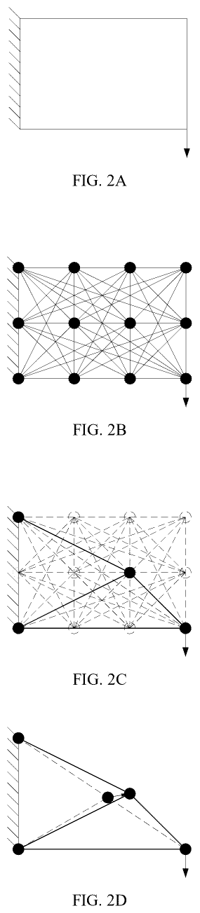

In step S1, initial design layout optimization: as shown in FIG. 2A to FIG. 2D, in step S1, the main steps include: step S1.1, defining a design domain and a boundary condition, as shown in FIG. 2A; step S1.2, then discretizing the design domain into a node grid, and constructing a base structure including all possible connections between nodes, as shown in FIG. 2B; step S1.3, identifying and optimizing a subset structure from the base structure, as shown in FIG. 2C; step S1.4, using geometric optimization based on design variables of node coordinates to obtain reasonable optimization results, as shown in FIG. 2D.

In step S1, without taking into account modular requirements, Formula (1) and Formula (2) are used to perform initial design layout optimization to obtain an initial solution of the layout optimization, and the initial solution is set as a strict lower bound. The corresponding objective function with a minimum total volume of members as a design objective is:

$${min V}_{a , q , x , y} = {l ( x , y )}^{T} a \qquad ( 1 )$$

The expression of the constraint conditions is:

$$\{ \begin{matrix}B ( x , y ) q = f \\ - {σ}_{c} a \leq q \leq {σ}_{t} a \\ a \geq 0\end{matrix} \qquad ( 2 )$$

where V is a total volume of a member, l(x, y) is a vector of a member length, a is a vector of a member area, B(x, y) is an equilibrium matrix, q is a vector of a member internal force, f is a vector of a node load, and σ_{c} and σₜ are allowable compression strength and allowable tensile strength of the member, respectively; x=[x₁, x₂, . . . , xₗ]^{T} and y=[y₁, y₂, . . . , yₗ]^{T} are the x coordinate vector and the y coordinate vector of nodes, respectively, and l is the number of the nodes.

The three constraint conditions in Formula (2) represent an equilibrium equation of a force, a stress constraint of members and a non-negative constraint of a member area, respectively. The design variables include the vector a of a member cross-sectional area, the vector q of a member internal force, and the coordinates x, y. B(x, y) and l(x, y) denote the matrix and the vector generated according to the topology manner of the member, f is a constant vector corresponding to the actual working conditions, and σ_{c} and σₜ are constants corresponding to the actual working conditions.

In step S2, modular design layout optimization is performed, which includes: in consideration of modular requirements, performing the optimization by iteration, where each iteration consists of two main steps, so as to refine the initial solution of layout optimization obtained in step S1 into a modular design optimized solution of layout optimization.

In step S2.1, cluster analysis identification module arrangement is performed, which includes: solving the module arrangement determined by cluster analysis grouping Formula (3); checking structural layout by cluster analysis to identify the related module arrangement; and the cluster analysis is an unsupervised learning algorithm, which can divide objects in a data set into different groups according to the similarity. The similarity is quantified by an Euclidean distance to obtain an cluster index c as follows:

$$c = arg {min}_{S} {\sum }_{ϕ = 1}^{p} {\sum }_{ζ ∈ {S}_{ϕ}} {‖ ζ - {μ}_{ϕ} ‖}^{2} \qquad ( 3 )$$

where S={S₁, S₂, . . . , S_{ϕ}, . . . , Sₚ} is a data cluster set, where S_{ϕ} denotes a ϕ-th data cluster, and p is a total number of data clusters, which is equal to the number of module types in the optimization problem; ζ is a data point belonging to S_{ϕ};

$${μ}_{ϕ} = \frac{1}{\vert {S}_{ϕ} \vert} {\sum }_{ζ ∈ {S}_{ϕ}} ζ$$

is a centroid of S_{ϕ}, where |S_{ϕ}| is the corresponding number of data points.

In step S2.2, relaxed modular constraint design is performed, which includes: re-optimizing a structure by using the determined modular arrangement and by applying relaxed modular constraints, so that the initial solution turns to a more modular design.

In step S3, geometric optimization is performed, which includes: performing geometric optimization processing on layout optimization results to obtain a reasonable and effective optimization structure.

In step S4, 3D printing manufacturing and integrated assembly is performed, which includes: performing 3D modeling, slicing a plurality of modular cells in optimized result module, generating a printing path, performing 3D printing manufacturing for each modular cell, performing integrated assembly among the modular cells, to manufacture an optimized structure.

### Embodiment 2

As another embodiment, Embodiment 2 proposes a more specific three-dimensional truss optimal designing and manufacturing method based on relaxed modular constraint on the basis of Embodiment 1. In step S2:

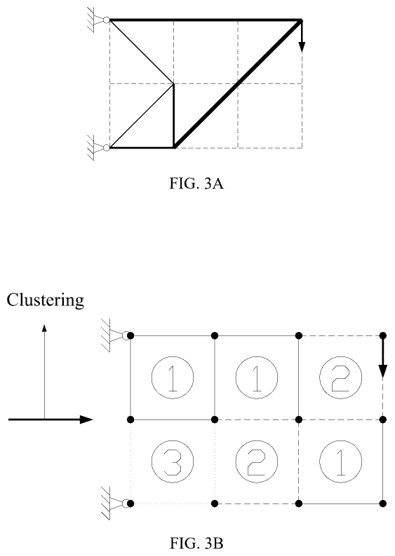

as shown in FIG. 3A to FIG. 3C, in step S2.1, a cluster analysis algorithm is used to extract the modular arrangement from the existing structure, and the main steps include steps S2.1.1-S2.1.3. In step S2.1.1, the design domain and the boundary condition are given, as shown in FIG. 3A. In step S2.1.2, an optimal modular arrangement is obtained by using a regional volume as data for clustering, that is, setting ζ=νₛ in Formula (3), where νₛ is a regional volume, as shown in FIG. 3B. In step S2.1.3, a linear programming problem is solved, the corresponding modular optimization structure after re-optimization is obtained, as shown in FIG. 3C, and expressions of solving the strict modular optimization problem are shown in Formula (4) and Formula (5), that is, a nominal lower bound solution. In this embodiment, the cantilever beam is taken as an example.

The objective function is:

$${min V}_{a , q , {A}_{m} , x , y} = {l ( x , y )}^{T} a \qquad ( 4 )$$

The expression of the constraint condition is:

$$\{ \begin{matrix}B ( x , y ) q = f \\ - {σ}_{c} a \leq q \leq {σ}_{t} a \\ a \geq 0 \\ {a}_{i} = {\sum }_{j = 1}^{p} {A}_{m , j} {t}_{j} , ∀ i ∈ \{ 1 , 2 , … , n \}\end{matrix} \qquad ( 5 )$$

where tⱼ is a binary constant representing the j-th module type number in each module space, which reflects whether the corresponding module type is activated; p is the number of the module types, and n is the number of the members; A_{m,j} is an optional area of the member in the j-th module.

The cluster analysis algorithm may lead to suboptimal solution, so that ζ=νₛ is set in Formula (3) in order to determine the optimal module arrangement and the nominal lower bound solution.

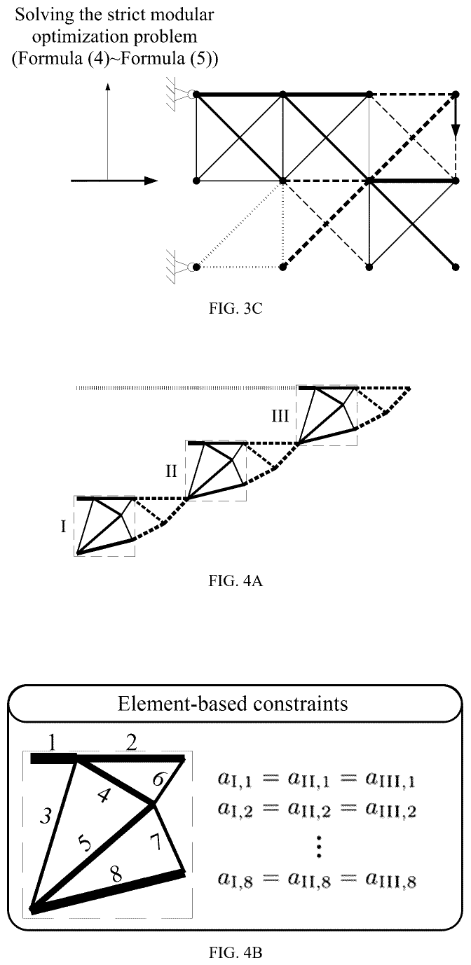

Step S2.2: as shown in FIG. 4A to FIG. 4D, the main steps of the relaxed modular constraint include steps S2.2.1-S2.2.4. In step S2.2.1, given structures of different module types are set, as shown in FIG. 4A. In step S2.2.2, the element-based modular constraint is set to ensure that internal structures of the module space of the same module type are all the same, where the structures of I, II and III as shown in FIG. 4A are the same, and the specific schematic diagram of the module structure is shown in FIG. 4B. In step S2.2.3, the module space is divided into d×d sub-regions, the volume of the sub-regions is constrained, as shown in FIG. 4C. In step S2.2.4, when a value of d is large enough, the region-based modular constraint is close to result of the element-based modular constraint; therefore, a small value of d is selected, and the region-based modular constraint is equivalent to the relaxed modular constraint (FIG. 4D); the expressions of the relaxed modular constraint are shown in Formula (6) and Formula (7) to replace a fourth expression in Formula (5).

$${v}_{s , ( k , b )} = {v}_{t , ( j , b )} , ∀ k ∈ {H}_{j} , b = 1 , 2 , … , {d}^{2} \qquad ( 6 )$$

$${v}_{s , ( k , b )} = {\sum }_{m ∈ {Ω}_{k , b}} {a}_{k , m} {l}_{k , m} \qquad ( 7 )$$

where ν_{s,(k,b)} denotes the structural volume of the b-th sub-region in the k-th module space, ν_{t,(j,b)} denotes a total volume of the b-th module region in the j-th module type; Hⱼ denotes an index set of the module space when the j-th module type is used; Ω_{k,b} is the b-th sub-region in the k-th module space; a_{k,m} and l_{k,m} are the cross-sectional area and the length of the member in the b-th sub-area, respectively, and m is the member number.

In the optimization process, the modular constraints are capable of being strengthened by systematically increasing the value of d. However, the increase of the value of d may also lead to a discrete jump of sub-regions. This sudden jump results in significant changes between iterations, which will lead to convergence problems. In order to solve the convergence problem and ensure a smooth transition between iterations, the constraint Formula (6) is modified by a more gradual constraint Formula (8).

$$( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \qquad ( 8 )$$

where r is an influencing factor, 0≤r≤1, when r=1, the constraint Formula (6) is completely eliminated, and when r=0, the constraint Formula (6) is fully applied, that is, more strict modular constraint; in the whole iterative process, the value of r starts from being close to 1 and gradually decreases to 0, thus gradually implementing stricter modular constraint.

In step S2.2, in the expression of solving a relaxed modular constraint optimization problem, the objective function is:

$${min V}_{a , q , x , y} = {l ( x , y )}^{T} \qquad ( 9 )$$

The expression of the constraint condition is:

$$\{ \begin{matrix}B ( x , y ) q = f \\ - {σ}_{c} a \leq q \leq {σ}_{t} a \\ a \geq 0 \\ ( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \\ {v}_{s , ( k , b )} = {\sum }_{m ∈ {Ω}_{k , b}} {a}_{k , m} {l}_{k , m}\end{matrix} \qquad ( 10 )$$

where the constraint condition Formula (10) consists of the first three expressions of Formula (5), Formula (7) and Formula (8).

Further, an improved iterative implementation strategy is used between step S2.1 and step S2.2 to improve a final optimization result, which specifically includes: after step S2.1, when ν_{ξ}≤ν_{ξ-1}, the module arrangement is updated, and then implementing step S2.2 to solve the relaxed modular constraint optimization problem; when ν_{ξ}≤ν_{ξ-1}, implementing step S2.2 directly to solve the relaxed modular constraint optimization problem; where ν_{ξ} is a volume of the modular optimization structure, which is solved by Formula (5); ξ is the number of iterations, and ξₘₐₓ is the predetermined maximum number of iterations.

Step S3 specifically includes: performing geometric optimization processing on layout optimization result to obtain a reasonable and effective optimization structure.

Step S4 specifically includes: extracting the structural information of modular cells according to the optimization result, where the structural information includes a mode of the modular cell, a position of the modular cell, a connection of the modular cell and a section size of the member of the modular cell; after the member assembly and node generation of the modular cell are performed, establishing a 3D solid model, thereafter, slicing a plurality of modular cells in the entity model, to generate a printing path, and performing 3D printing manufacturing for each modular cell; thereafter, connecting the modular cells to complete integrated assembly to manufacture an optimized structure.

It should be noted that the same or similar parts in this embodiment as in Embodiment 1 can be referenced to each other, which will not be described in detail in the present disclosure.

### Embodiment 3

As another embodiment, Embodiment 3 proposes to perform optimal designing and manufacturing for the simple bridge through the solution of the initial design layout optimization in step S1 and the modular design layout optimization in step S2 in the three-dimensional truss optimal designing and manufacturing method based on relaxed modular constraint on the basis of Embodiment 1 and Embodiment 2.

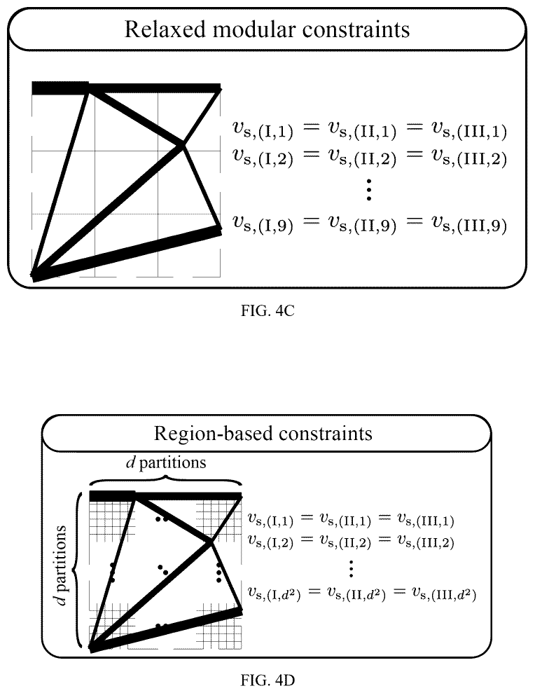

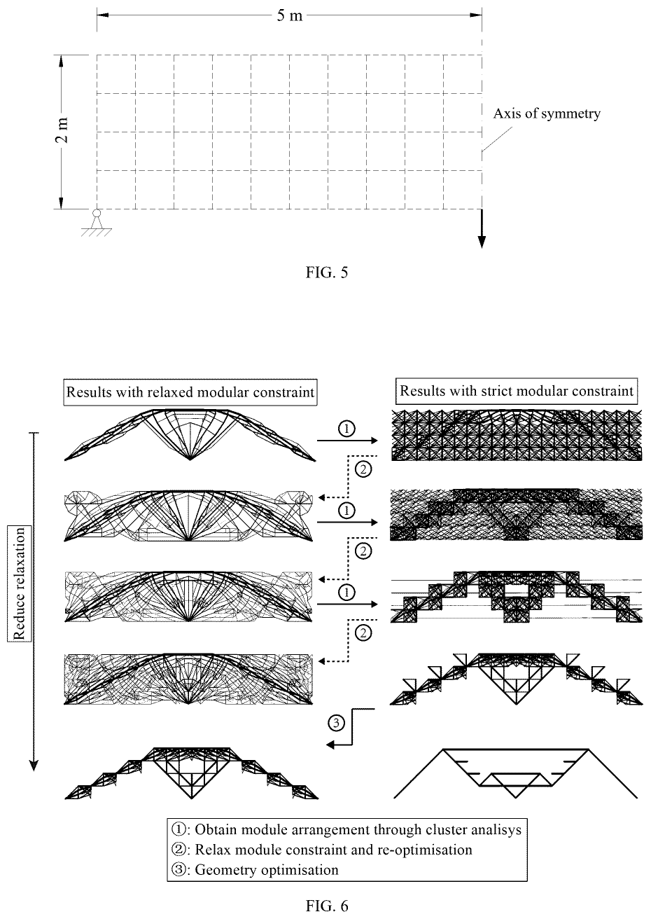

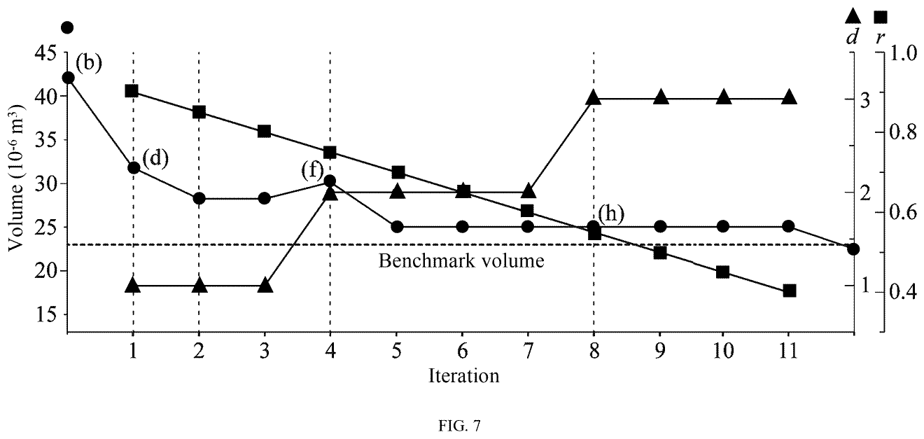

As shown in FIG. 5, the semi-structure of the simple bridge is optimized according to symmetry, that is, the design domain of 5 m×2 m is selected. The vertical load/=0.5N is applied to the lower right corner of the design domain, the module size is 0.5 m×0.5 m, the number of module types is p=4, and the module complexity is 4×4. The optimization results of each step are expanded to a full size according to symmetry. FIG. 6 shows the structural changes of an optimization process. FIG. 7 shows the changes of a structural volume, a variable d and a variable r in an iterative process.

First, the initial design layout optimization in step S1 is performed according to Formula (1) and Formula (2), and the optimization result is obtained, as shown in the upper left corner of FIG. 6.

Thereafter, in the cluster analysis identification module arrangement in step S2.1, the cluster analysis grouping is performed according to Formula (3) by using the modular cell region data of initial design layout optimization in FIG. 6, which lays a foundation for developing an initial modular structure.

Thereafter, the strict modular constraint optimization Formula (4) and Formula (5) are solved to obtain the module arrangement optimization result, as shown in the upper right corner of FIG. 6.

In each iteration, the optimization Formula (9) and Formula (10) of the relaxed modular constraint design in step S2.2 are applied to obtain intermediate optimization result, as shown in the left side of lines 2 to 4 in FIG. 6. With the advancement of optimization, the relaxation degree decreases, pushing the intermediate optimization result to the modular structure.

The module arrangement is updated accordingly, as shown in the right side of lines 2 to 4 in FIG. 6, resulting in the volume reduction of the corresponding modular structure, as shown in FIG. 7. In this implementation, the iterative process ends at the 11th iteration. At this time, d=3 and r=0.4, and the optimized volume is 25.04×10⁻⁶ m³.

Finally, the structure is rationalized by geometric optimization, and the result in the lower left corner of FIG. 6 is obtained. By simplifying the internal structure of each type of modules and deleting the stress-free module, the structural volume is further reduced to 23.00×10⁻⁶ m³.

The optimization result of the two-step optimization method is shown in the lower right corner of FIG. 6. In contrast, the structural volume corresponding to the optimization result of the method disclosed in present disclosure is reduced by about 2.2%, and it only takes 53 s to calculate by the CPU, while it takes 10951 s for the two-step optimization method. Therefore, the calculation time of the CPU in the method disclosed in present disclosure is reduced by 99.50%, and the calculation efficiency is significantly improved.

FIG. 7 shows the changes of a modular structural volume in the whole iterative process. Except for the fourth iteration, the structural volume produced by most iterations is the same as the results of the previous steps or is improved from the results of the previous steps. After six iterations, the module arrangement and the structural volume change little, indicating that the algorithm has tended to converge.

### Embodiment 4

As another embodiment, the Embodiment 4 proposes the application of the three-dimensional truss optimal designing and manufacturing method based on relaxed modular constraint in the three-dimensional truss model of the square roof supported on four sides on the basis of Embodiment 1 and Embodiment 2

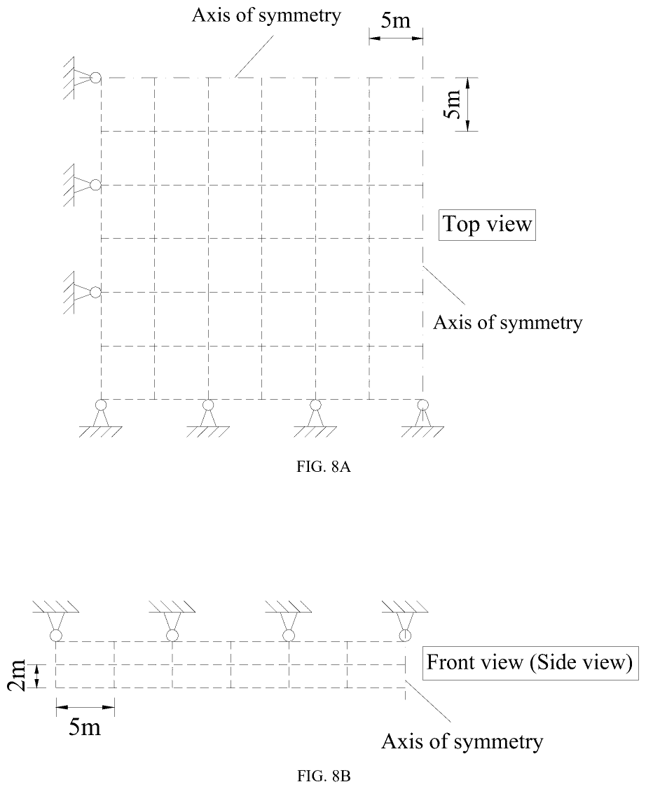

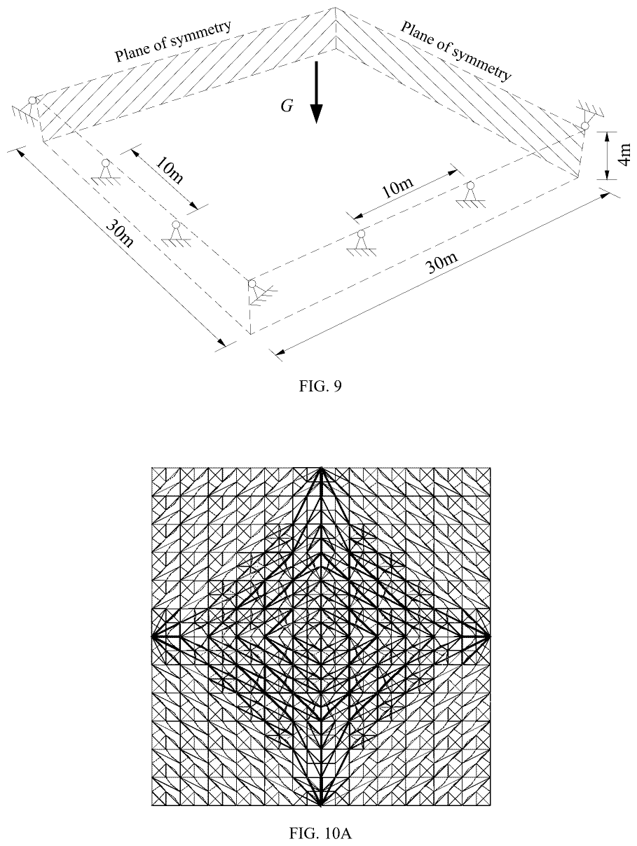

As shown in FIG. 8A and FIG. 8B, the square roof truss structure with a span of 60 m is optimized, and a quarter structure is taken into account for simplified analysis according to symmetry. The full-scale roof structure includes a grid of 12×12×2 modules. Six different module types are used, and the complexity of each module is 3×3×3. A support is provided at intervals of 10 m along the four-side boundary of the structure. The vertical load is applied to each node on the top surface of the structure, that is, the full-span load, to accurately simulate the action of the gravity load G, as shown in FIG. 9.

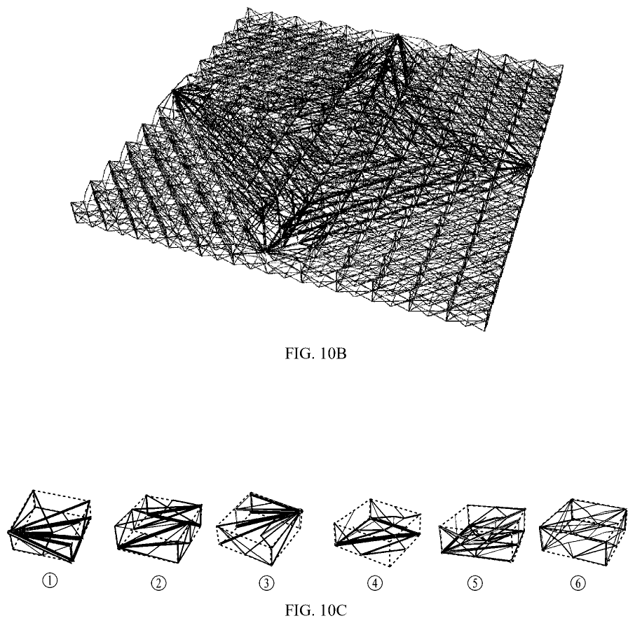

As shown in FIG. 10A to FIG. 10C, the optimized results of the method disclosed in present disclosure are as follows. Under the full-span load condition, the optimized structural volume of the six different module types in FIG. 10C is 5462×10⁻⁶ m³, and the optimized solution time is 1289 s. As a comparative example, one module type is used for solution, and the corresponding optimized volume is 8614×10⁻⁶ m³. The results show that the volume can be reduced by 36.5% at most by increasing the number of module types from 1 to 6.

As can be seen from Embodiment 3 and Embodiment 4, according to the three-dimensional truss optimal designing and manufacturing method based on relaxed modular constraint provided by the present disclosure, based on the mathematical model of truss layout optimization, fast and efficient solution based on relaxed modular constraints is realized through the iterative solution mode of cluster analysis identification module arrangement. The relaxed modular constraints of various types of modules are set, so that the module repeatability and the structural regularity of the optimization results are realized. The calculation efficiency is significantly improved with little influence on a final optimized structural volume. Through 3D modeling, modular structure model slicing, printing path generation and integrated assembly production, 3D printing optimization design and integrated assembly manufacturing of a complex three-dimensional truss optimization structure are realized. Moreover, the practical verification proves that the method is effective.

Each embodiment in this specification is described in a progressive manner. Each embodiment focuses on the differences from other embodiments. The same or similar parts between the embodiments can be referenced to each other.

What is claimed is:

1. A three-dimensional truss optimal designing and manufacturing method based on relaxed modular constraint, comprising:
step S1, performing initial design layout optimization, comprising: carrying out initial design layout optimization with a minimum total volume of members as a design objective to obtain an initial solution of layout optimization, and setting the initial solution as a strict lower bound;
step S2, performing modular design layout optimization, comprising: repeating step S2.1 and step S2.2 to refine the initial solution of layout optimization into a modular design optimized solution of layout optimization;
step S2.1, performing cluster analysis identification module arrangement, comprising: checking structural layout by cluster analysis, identifying module arrangement, and solving a strict modular constraint optimization problem;
step S2.2, performing relaxed modular constraint design, comprising: re-optimizing a structure through the relaxed modular constraint by using module arrangement;
step S3, performing geometric optimization, comprising: performing geometric optimization processing on a layout optimization result to obtain a reasonable and effective optimization result;
step S4, performing three-dimension (3D) printing manufacturing and integrated assembly, comprising: performing 3D printing manufacturing on a plurality of optimized modular cells, and performing integrated assembly among the modular cells to manufacture an optimized structure.

2. The three-dimensional truss optimal designing and manufacturing method according to claim 1, wherein in step S1, a corresponding objective function with the minimum total volume of the members as the design objective is:
$${min V}_{a , q , x , y} = {l ( x , y )}^{T} a \qquad ( 1 )$$
an equilibrium equation of a force, a stress constraint of the members and a non-negative constraint of a member cross-sectional area are introduced as constraint conditions of Formula (1), and an expression of the constraint conditions is:
$$\{ \begin{matrix}B ( x , y ) q = f \\ - {σ}_{c} a \leq q \leq {σ}_{t} a \\ a \geq 0\end{matrix} \qquad ( 2 )$$
where V is a total volume of the members, l(x, y) is a vector of a member length, a is a vector of the member cross-sectional area, B(x, y) is an equilibrium matrix, q is a vector of a member internal force, f is a vector of a node load, and σ_{c} and σₜ are allowable compression strength and allowable tensile strength of the members, respectively; x=[x₁, x₂, . . . , xₗ]^{T} and y=[y₁, y₂, . . . , yₗ]^{T} are an x coordinate vector and y coordinate vector of a node, respectively, and l is a number of nodes.

3. The three-dimensional truss optimal designing and manufacturing method according to claim 1, wherein in step S1, a design domain and a boundary condition are defined first, the design domain is then discretized into a node grid, and a base structure comprising all possible connections between the nodes is constructed; a subset structure is identified and optimized from the base structure; and geometric optimization is performed based on design variables of node coordinates.

4. The three-dimensional truss optimal designing and manufacturing method according to claim 1, wherein in step S2.1, objects in a data set are divided into different groups by cluster analysis according to similarity, the similarity is quantified by an Euclidean distance, and then a cluster index c is obtained from following formula:
$$c = arg {min}_{S} {\sum }_{ϕ = 1}^{p} {\sum }_{ζ ∈ {S}_{ϕ}} {‖ ζ - {μ}_{ϕ} ‖}^{2} \qquad ( 3 )$$
where S={S₁, S₂, . . . , S_{ϕ}, . . . , Sₚ} is a data cluster set, where S_{ϕ} denotes a ϕ-th data cluster, and p is a total number of data clusters, which is equal to a number of module types in the optimization problem; ξ is a data point belonging to S_{ϕ};
$${μ}_{ϕ} = \frac{1}{\vert {S}_{ϕ} \vert} {\sum }_{ζ ∈ {S}_{ϕ}} ζ$$
is a centroid of S_{ϕ}, where |S_{ϕ} is a corresponding number of data points;
using a cluster analysis algorithm to extract a modular arrangement from existing structure according to divided groups, comprises: first, giving a design domain and a boundary condition, obtaining an optimal modular arrangement by using a regional volume as data for clustering, which means to set ξ=νₛ in Formula (3), wherein νₛ is the regional volume; finally, solving a linear programming problem to obtain corresponding modular optimization structure after re-optimization, and solving a strict modular optimization problem to obtain a nominal lower bound solution.

5. The three-dimensional truss optimal designing and manufacturing method according to claim 4, wherein in step S2.1, for an expression of solving the strict modular constraint optimization problem, an objective function is:
$${min V}_{a , q , {A}_{m} , x , y} = {l ( x , y )}^{T} a \qquad ( 4 )$$
an expression of constraint conditions is:
$$\{ \begin{matrix}B ( x , y ) q = f \\ - {σ}_{c} a \leq q \leq {σ}_{t} a \\ a \geq 0 \\ {a}_{i} = {\sum }_{j = 1}^{p} {A}_{m , j} {t}_{j} , ∀ i ∈ \{ 1 , 2 , … , n \}\end{matrix} \qquad ( 5 )$$
where tⱼ is a binary constant representing a j-th module type number in each module space, which reflects whether a corresponding module type is activated; p is a number of module types, and n is a number of cells; A_{m,j} is an optional area of a member in a j-th module.

6. The three-dimensional truss optimal designing and manufacturing method according to claim 5, wherein in step S2.2, given structures of different module types are set; an element-based modular constraint is set as a relaxed modular constraint to ensure that internal structures of module spaces of a same module type are all same; each module space is divided into d×d sub-regions, each sub-region has its corresponding structure, volume of the sub-regions is constrained by following expression:
$${v}_{s , ( k , b )} = {v}_{t , ( j , b )} , ∀ k ∈ {H}_{j} , b = 1 , 2 , … , {d}^{2} \qquad ( 6 )$$
$${v}_{s , ( k , b )} = {\sum }_{m ∈ {Ω}_{k , b}} {a}_{k , m} {l}_{k , m} \qquad ( 7 )$$
where ν_{s,(k,b)} denotes a structural volume of a b-th sub-region in a k-th module space, ν_{t,(j,b)} denotes a total volume of a b-th module region in a j-th module type; Hⱼ denotes an index set of module spaces when the j-th module type is used; Ω_{k,b} is the b-th sub-region in the k-th module space; a_{k,m} and l_{k,m} are a cross-sectional area and length of a member in the b-th sub-region, respectively, and m is a member number;
a fourth expression in Formula (5) is replaced by Formula (6) and Formula (7), and expression of the relaxed modular constraint design is obtained.

7. The three-dimensional truss optimal designing and manufacturing method according to claim 6, wherein in step S2.2, the modular constraint are capable of being strengthened by systematically increasing a value of d; in order to solve a convergence problem resulted from a discrete jump of sub-regions due to increase of the value of d, Formula (6) is modified to Formula (8), which is expressed as:
$$( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \qquad ( 8 )$$
where r is an influencing factor, 0≤r≤1, when r=1, constraint Formula (6) is completely eliminated, and when r=0, the constraint Formula (6) is fully applied; in a whole iterative process, a value of r starts from being close to 1 and gradually decreases to 0.

8. The three-dimensional truss optimal designing and manufacturing method according to claim 7, wherein in step S2.2, for an expression of solving a relaxed modular constraint optimization problem, an objective function is:
$${min V}_{a , q , {v}_{t} , {v}_{s} , x , y} = {l ( x , y )}^{T} a \qquad ( 9 )$$
an expression of constraint conditions is:
$$\{ \begin{matrix}B ( x , y ) q = f \\ - {σ}_{c} a \leq q \leq {σ}_{t} a \\ a \geq 0 \\ ( 1 - r ) {v}_{t , ( j , b )} \leq {v}_{s , ( k , b )} \leq {v}_{t , ( j , b )} , ∀ k ∈ {H}_{j} , b = 1 , 2 , … , {d}^{2} \\ {v}_{s , ( k , b )} = {\sum }_{m ∈ {Ω}_{k , b}} {a}_{k , m} {l}_{k , m}\end{matrix} \qquad ( 10 )$$
where constraint condition Formula (10) consists of first three expressions of Formula (5), Formula (7) and Formula (8).

9. The three-dimensional truss optimal designing and manufacturing method according to claim 5, wherein in step S2, an improved iterative implementation strategy is used from step S2.1 to step S2.2 to improve a final optimization result, which includes: after step S2.1, when ν_{ξ}≤ν_{ξ-1}, updating the module arrangement, and then implementing step S2.2 to solve a relaxed modular constraint optimization problem; when ν_{ξ}≤ν_{ξ-1}, implementing step S2.2 directly to solve the relaxed modular constraint optimization problem; where ν_{ξ} is a volume of the modular optimization structure, which is solved by Formula (5); ξ is a number of iterations, and ξₘₐₓ is a predetermined maximum number of iterations.
